(19) United States
(12) Patent Application Publication
(10) Pub. No.: US 2020/0293760 A1
(43) Pub. Date: Sep. 17, 2020

(54) MULTI-MODAL IDENTITY RECOGNITION

(71) Applicant: Alibaba Group Holding Limited, George Town (KY)

(72) Inventors: Jiankang Sun, Hangzhou (CN); Xiaobo Zhang, Hangzhou (CN); Xiaodong Zeng, Hangzhou (CN)

(73) Assignee: Alibaba Group Holding Limited, George Town (KY)

(21) Appl. No.: 16/888,491

(22) Filed: May 29, 2020

Related U.S. Application Data
(63) Continuation of application No. PCT/CN2018/123110, filed on Dec. 24, 2018.

(30) Foreign Application Priority Data
Jan. 3, 2018 (CN) 201810004129.8

(51) Int. Cl. G06K 9/00; G06K 9/62; G06Q 20/40

(52) U.S. Cl. CPC G06K 9/00288; G06K 9/00617; G06K 9/0061; G06Q 20/40145; G06K 9/6202; G06K 9/00335; G06K 9/00268

(57) ABSTRACT

Implementations of the present specification disclose methods, apparatuses, and devices for recognizing an identity of a first user from multiple users in an environment. In one aspect, the method includes: obtaining, from one or more monitoring devices, one or more video streams including images of the multiple users in the environment; obtaining, from a touch-enabled device, information indicative of a touch; identifying, based on the one or more video streams and the information indicative of the touch, a particular user from the multiple users as the first user; obtaining biometric features of the first user; and performing identity recognition of the first user based on the biometric features of the first user.

### CROSS-REFERENCE TO RELATED APPLICATIONS

This application is a continuation of PCT Application No. PCT/CN2018/123110, filed on Dec. 24, 2018, which claims priority to Chinese Patent Application No. 201810004129.8, filed on Jan. 3, 2018, and each application is hereby incorporated by reference in its entirety.

### TECHNICAL FIELD

Implementations of the present specification relate to the field of identity recognition technologies, and in particular, to identity recognition methods, apparatuses, and systems.

### BACKGROUND

In the network society, how to recognize user identities is a prerequisite for implementing internet commerce (electronic finance) and smart payment (facial recognition-based payment).

### SUMMARY

Implementations of the present specification provide identity recognition methods, apparatuses, and systems.

According to a first aspect, an implementation of the present specification provides an identity recognition method, used to: based on one or more touch-enabled devices and one or more monitoring devices that are on a real-world user side, recognize an identity of a first user from multiple users on the user side by using an identity recognition model on a server side; and the method includes: recognizing a touching on the touch-enabled device, and obtaining video streams of the multiple users that are recorded by the monitoring device; locking, based on the video streams, a user who performs the touching as the first user, and obtaining biometric features of the first user; and recognizing the identity of the first user based on the biometric features of the first user.

According to a second aspect, an implementation of the present specification provides an identity recognition model, configured to: based on one or more touch-enabled devices and one or more monitoring devices that are on a real-world user side, recognize an identity of a first user from multiple users on the user side by using the identity recognition model on a server side; and the identity recognition model includes: a touching recognition unit, configured to recognize a touching on the touch-enabled device; a video stream acquisition unit, configured to obtain video streams of the multiple users that are recorded by the monitoring device; a user locking unit, configured to lock, based on the video streams, a user who performs the touching as the first user; a user biometric feature acquisition unit, configured to obtain biometric features of the first user based on the video streams; and an identity recognition unit, configured to recognize the identity of the first user based on the biometric features of the first user.

According to a third aspect, an implementation of the present specification provides an identity recognition system, including one or more touch-enabled devices, one or more monitoring devices, and an identity recognition model, and configured to recognize an identity of a first user from multiple users on a server side based on the touch-enabled device and the monitoring device that are on a real-world user side, where the touch-enabled device is touchable by a user, so as to record a touching; the monitoring device is configured to obtain video streams of the multiple users and upload the video streams to the identity recognition model; and the identity recognition model is configured to: recognize a touching of a user on the touch-enabled device, lock, based on the video streams of the monitoring device, the first user that performs the touching, obtain user biometric features of the first user, and perform identity recognition based on the user biometric features.

According to a fourth aspect, an implementation of the present specification provides a server, including a memory, a processor, and a computer program that is stored in the memory and that can run on the processor, where when executing the program, the processor implements steps of the previous identity recognition method.

According to a fifth aspect, an implementation of the present specification provides a computer readable storage medium. The computer readable storage medium stores a computer program, and the program is executed by a processor to implement steps of the previous identity recognition method.

Beneficial effects of the implementations of the present specification are as follows:

In the identity recognition method provided in the implementations of the present disclosure, user biometric feature recognition is associated with touching recognition. Only when the user biometric features and the user who performs the touching belong to the same current user, identity recognition of the current user is performed, and subsequent operations such as payment transactions based on the biometric features are performed. This effectively alleviates the problem of ineffective identity recognition based only on the biometric features in crowds.

A specific application scenario is described. For example, in a bus facial recognition-based payment scenario, if only facial recognition is used, it may be unable to recognize a current user from crowds. Therefore, touching recognition is added on the basis of facial recognition, and only when it is determined that the face and the user who performs the touching belong to the same current user, facial recognition-based payment is performed on the current user.

### BRIEF DESCRIPTION OF DRAWINGS

FIG. 1 is a schematic diagram illustrating an identity recognition application scenario, according to an implementation of the present application;

FIG. 2 is a flowchart illustrating an identity recognition method, according to a first aspect of an implementation of the present specification;

FIG. 3 is a schematic implementation diagram illustrating example 1 of an identity recognition method, according to a first aspect of an implementation of the present specification;

FIG. 4 is a schematic implementation diagram illustrating example 2 of an identity recognition method, according to a first aspect of an implementation of the present specification;

FIG. 5 is a schematic structural diagram illustrating an identity recognition model, according to a second aspect of an implementation of the present specification;

FIG. 6 is a schematic structural diagram illustrating an identity recognition system, according to a third aspect of an implementation of the present specification;

FIG. 7 is a schematic structural diagram illustrating an identity recognition server, according to a fourth aspect of an implementation of the present specification.

### DESCRIPTION OF IMPLEMENTATIONS

To better understand the previous technical solutions, the following describes the technical solutions in the implementations of the present specification in detail by using the accompanying drawings and specific implementations. It should be understood that specific features in the implementations of the present specification and the implementations are detailed descriptions of the technical solutions in the implementations of the present specification, but not limitations on the technical solutions of the present specification. In a case of no conflict, the technical features in the implementations of the present specification and the implementations can be mutually combined.

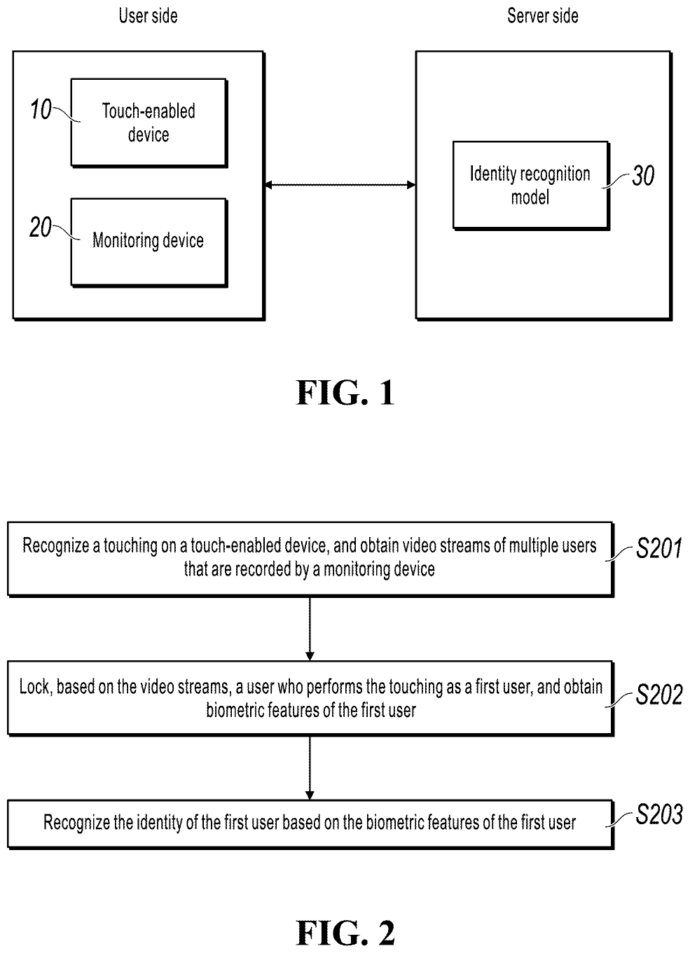

FIG. 1 is a schematic diagram illustrating an identity recognition application scenario, according to implementations of the present application. A real world user side includes one or more monitoring devices 10 and one or more touch-enabled devices 20. A server side includes an identity recognition model 30. The monitoring device 10 can be a camera device, configured to monitor biometric features and behaviors of a user, and upload the monitored video streams to the identity recognition model 30 in real time. The touch-enabled device 20 can be a device that provides the user with a form of a push button etc., and is touchable by the user, so as to perform a touching. The touch-enabled device 20 can be in communication with the identity recognition model 30. The identity recognition model 30 can be a server-side recognition management system (server), configured to: recognize a touching, determine user biometric features of a user who performs the touching, and perform identity recognition based on the user biometric features.

According to a first aspect, an implementation of the present specification provides an identity recognition method, used to: based on one or more touch-enabled devices and one or more monitoring devices that are on a real-world user side, recognize an identity of a first user from multiple users on the user side by using an identity recognition model on a server side. Scenarios on the user side include: a face recognition-based payment and/or iris scanning-based payment scenario, a face recognition-based access and/or iris scanning-based access scenario, a face recognition-based public transportation boarding scenario and/or iris scanning-based public transportation boarding scenario.

Referring to FIG. 2, the previous method includes S201 to S203.

S201. Recognize a touching on the touch-enabled device, and obtain video streams of the multiple users that are recorded by the monitoring device.

The touch-enabled device can be a device that exists in a form of a push button etc. A touching is performed when the user presses the push button. The touching can be directly reported by the touch-enabled device to the identity recognition model, or can be recognized by the identity recognition model after performing image analysis based on video streams uploaded by the monitoring device (the monitoring device monitors a touch behavior of the user on the touch-enabled device).

S202. Lock, based on the video streams, a user who performs the touching as the first user, and obtain biometric features of the first user.

The monitoring device monitors the user and sends the monitored video streams to the identity recognition model in real time. After performing operations such as image analysis and processing based on the video streams from the monitoring device, the identity recognition model can obtain user biometric features of the user who performs the touching. The user biometric features include but are not limited to facial features of the user, iris features of the user, behavioral features of the user, etc. For example, a process of obtaining the biometric features of the first user is: performing image analysis on a video stream corresponding to the first user, to obtain an image of the first user, and performing biometric feature extraction based on the image of the first user, to obtain the biometric features of the first user.

In an implementation, a process of recognizing the touching of the user on the touch-enabled device is as follows: After the user performs the touching on the touch-enabled device, the touch-enabled device reports the touching to the identity recognition model. Correspondingly, a method of locking, based on the video streams, a user who performs the touching as the first user is: determining a timestamp of the touching based on the touching reported by the touch-enabled device; and searching the video streams uploaded by the monitoring device for a video stream corresponding to the timestamp, and recognizing a user in the video stream corresponding to the timestamp as the first user; and video streams of the multiple users photographed by the monitoring device.

In another implementation, a process of recognizing the touching of the user on the touch-enabled device is as follows: The monitoring device monitors a behavior that the user performs the touching on the touch-enabled device, and uploads, to the identity recognition model, a video stream that includes a performing behavior of the touching. Correspondingly, a process of locking, based on the video streams, a user who performs the touching as the first user is: determining the user who performs the touching as the first user based on image analysis on the video stream that includes the performing behavior of the touching.

S203. Recognize the identity of the first user based on the biometric features of the first user.

After the biometric features of the first user are obtained, the obtained biometric features of the first user are compared with prestored user identity features. If the biometric features of the first user are included in the prestored user identity features, the first user is determined as a prestored user.

After identity recognition is performed, an identity recognition result can be further confirmed, and information about the identity recognition result can be communicated. For example, identity recognition completion can be prompted by using a sound, a text, etc. For example, when the user identity recognition result is a prestored user (for example, a valid user, an authorized user, or a user having a sufficient account balance), information such as “valid user” or “payment completed” (for example, in a facial recognition-based payment scenario) is played by sound.

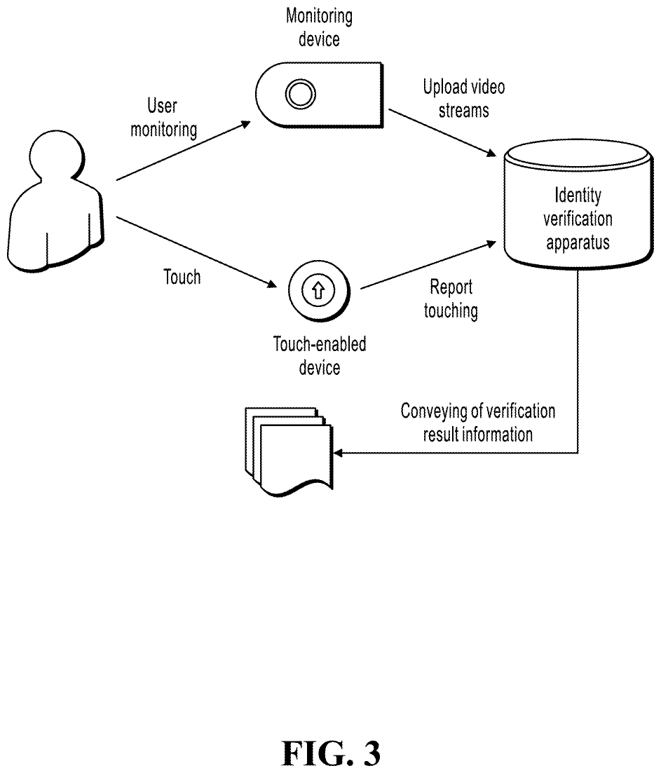

FIG. 3 is a schematic implementation diagram illustrating example 1 of an identity recognition method, according to a first aspect of an implementation of the present specification. Example 1 shows a process of implementing identity recognition of a user on an identity recognition model based on one or more touch-enabled devices and one or more monitoring devices. In Example 1, the touch-enabled device communicates with the identity recognition model. When the user performs a touching, the touch-enabled device reports the touching to the identity recognition model.

First, the monitoring device monitors user biometric features of a current user. At almost the same time, the user performs a touching on the touch-enabled device. Certainly, there can be an order between “the monitoring device monitors user biometric features of a current user” and “the user performs a touching on the touch-enabled device”, but the order has no impact on implementation of this implementation of the present disclosure.

Then, the touch-enabled device recognizes the touching and reports the touching to the identity recognition model. At almost the same time, the monitoring device uploads monitored video streams of the user biometric features of the current user to the identity recognition model. Certainly, there can be an order between “the touch-enabled device recognizes the touching and reports the touching to the identity recognition model” and “the monitoring device uploads monitored video streams of the user biometric features of the current user to the identity recognition model”, but the order has no impact on implementation of this implementation of the present disclosure.

Then, after receiving the touching report of the touch-enabled device, the identity recognition model determines a timestamp of the touching, and correspondingly searches, based on the timestamp, the video streams uploaded by the monitoring device for the user biometric features, to determine the user biometric features of the user who performs the touching. For example, it is determined, based on the timestamp, that an occurrence time of the touching is 16:05:30, and the corresponding video stream is searched for based on the time. Or the corresponding video stream can be searched for within a specific time period before and after the time, for example, a video stream within 5s before and after the time, that is, a video stream within 16:05:25-16:05:35, is searched for. The user biometric features can be obtained by means of image analysis and processing on the video stream.

Finally, the identity recognition model recognizes the user by comparing the obtained user biometric features with prestored user identity features. After identity recognition is performed, an identity recognition result can be further confirmed, and information about the identity recognition result can be communicated. For example, identity recognition completion can be prompted by using a sound, a text, etc. For example, when the user identity recognition result is a valid user, information such as “valid user” or “payment completed” (for example, in a facial recognition-based payment scenario) is played by sound.

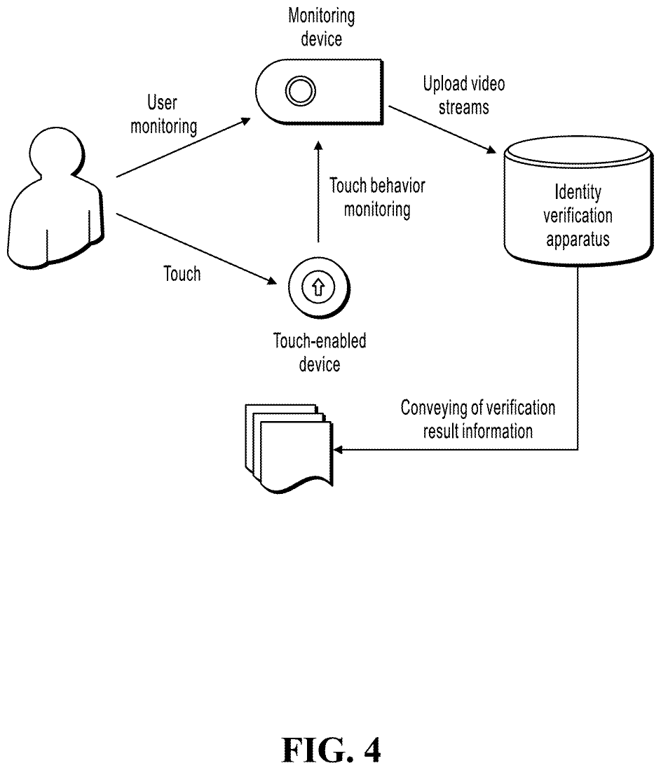

FIG. 4 is a schematic implementation diagram illustrating example 2 of an identity recognition method, according to a first aspect of an implementation of the present specification. Example 2 shows a process of implementing identity recognition of a user on an identity recognition model by collaboration between one or more touch-enabled devices and one or more monitoring devices. In Example 2, the monitoring device monitors not only biometric features of the user, but also a touch behavior of the user on the touch-enabled device. When the user performs the touching, the identity recognition model recognizes the touching by analyzing video streams uploaded by the monitoring device.

First, the monitoring device monitors the user, and monitors the touch behavior of the user on the touch-enabled device. At almost the same time, the user performs the touching on the touch-enabled device. Certainly, there can be an order between “the monitoring device monitors the user” and “the user performs the touching on the touch-enabled device”, but the order has no impact on implementation of this implementation of the present disclosure.

Then, the monitoring device uploads, to the identity recognition model, a monitored video stream that includes the user biometric features of the current user and the touch behavior of the user on the touch-enabled device.

Then, the identity recognition model recognizes the touching of the user based on image analysis on the video stream. When the touching of the user is recognized based on image analysis on the video stream, the user biometric features of the user who performs the touching are recognized. For example, the current user who performs the touching can be locked based on image analysis on the video stream, and then the biometric features of the current user are obtained.

Finally, the identity recognition model recognizes whether the user is valid by comparing the obtained user biometric features with prestored valid user identity features. After identity recognition is performed, an identity recognition result can be further confirmed, and information about the identity recognition result can be communicated. For example, identity recognition completion can be prompted by using a sound, a text, etc. For example, when the user identity recognition result is a valid user, information such as “valid user” or “payment completed” (for example, in a facial recognition-based payment scenario) is played by sound.

It can be seen that in the identity recognition method provided in the implementations of the present disclosure, user biometric feature recognition is associated with touching recognition. Only when the user biometric features and the user who performs the touching belong to the same current user, identity recognition of the current user is performed, and subsequent operations such as payment transactions based on the biometric features are performed. This effectively alleviates the problem of ineffective identity recognition based only on the biometric features in crowds.

A specific application scenario is described. For example, in a bus facial recognition-based payment scenario, if only facial recognition is used, it may be unable to recognize a current user from crowds. Therefore, touching recognition is added on the basis of facial recognition, and only when it is determined that the face and the user who performs the touching belong to the same current user, facial recognition-based payment is performed on the current user. For another example, in an access control scenario, if there are many people, touching recognition can be added based on facial recognition, and only when it is determined that the face and the user who performs the touching belong to the same current user, the current user is allowed to access.

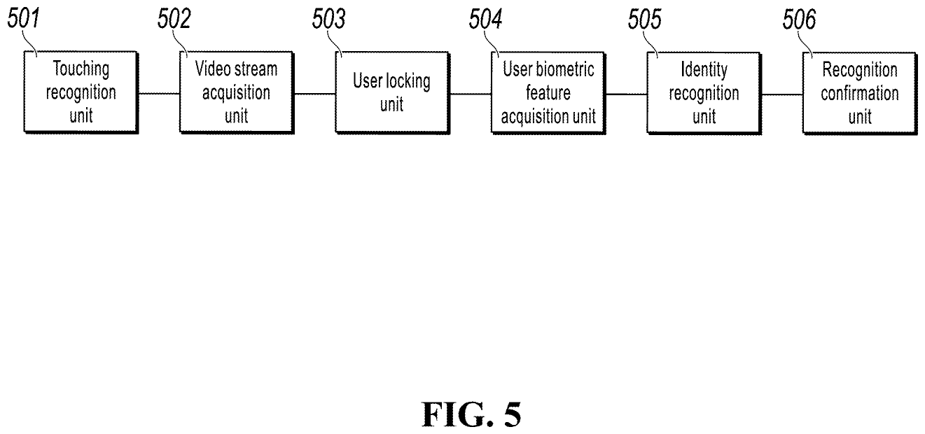

According to a second aspect, based on the same inventive concept, an implementation of the present specification provides an identity recognition model, configured to: based on one or more touch-enabled devices and one or more monitoring devices that are on a real-world user side, recognize an identity of a first user from multiple users on the user side by using the identity recognition model on a server side; and referring to FIG. 5, the identity recognition model includes: a touching recognition unit 501, configured to recognize a touching on the touch-enabled device; a video stream acquisition unit 502, configured to obtain video streams of the multiple users that are recorded by the monitoring device; a user locking unit 503, configured to lock, based on the video streams, a user who performs the touching as the first user; a user biometric feature acquisition unit 504, configured to obtain biometric features of the first user based on the video streams; and an identity recognition unit 505, configured to recognize the identity of the first user based on the biometric features of the first user.

In an optional implementation, the touching recognition unit 501 is specifically configured to: after the user performs the touching on the touch-enabled device, receive the touching reported by the touch-enabled device.

In an optional implementation, the user locking unit 503 is specifically configured to determine a timestamp of the touching based on the touching reported by the touch-enabled device; and search the video streams uploaded by the monitoring device for a video stream corresponding to the timestamp, and recognize a user in the video stream corresponding to the timestamp as the first user.

In an optional implementation, the touching recognition unit 501 is specifically configured to receive a video stream that includes a performing behavior of the touching and that is uploaded by the monitoring device.

In an optional implementation, the user locking unit 503 is specifically configured to: determine, based on image analysis on the video stream including the performing behavior of the touching, that the user who performs the touching is the first user.

In an optional implementation, the user biometric feature acquisition unit 504 is specifically configured to: perform image analysis on a video stream corresponding to the first user, to obtain an image of the first user; and perform biometric feature extraction based on the image of the first user, to obtain the biometric features of the first user.

In an optional implementation, the identity recognition unit 505 is specifically configured to: compare the obtained biometric features of the first user with prestored user identity features; and if the biometric features of the first user are included in the prestored user identity features, determine that the first user is a prestored user.

In an optional implementation, the apparatus further includes: a recognition confirmation unit 506, configured to confirm an identity recognition result and communicate information about the identity recognition result.

In an optional implementation, scenarios on the user side include: a facial recognition-based payment and/or iris scanning-based payment scenario, a facial recognition-based access and/or iris scanning-based access scenario, a facial recognition-based public transportation boarding scenario and/or iris scanning-based public transportation boarding scenario.

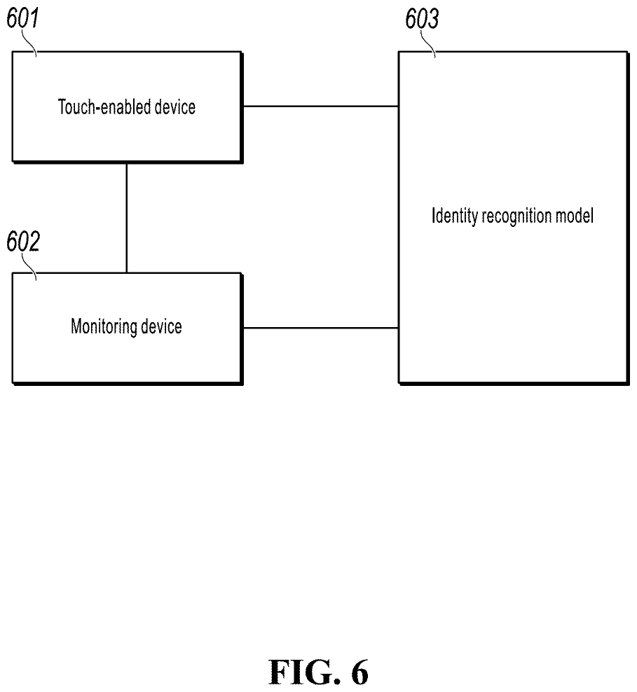

According to a third aspect, based on the same inventive concept, an implementation of the present specification provides an identity recognition system. Referring to FIG. 6, the identity recognition system includes one or more touch-enabled devices 601, one or more monitoring devices 602, and an identity recognition model 603, and is configured to: based on the touch-enabled device 601 and the monitoring device 602 that are on a real-world user side, recognize an identity of a first user from multiple users on the user side by using the identity recognition model 603 on a server side.

The touch-enabled device 601 is touchable by a user, so as to record a touching; the monitoring device 602 is configured to obtain video streams of the multiple users and upload the video streams to the identity recognition model 603; and the identity recognition model 603 is configured to: recognize a touching on the touch-enabled device 601, lock, based on the video streams of the monitoring device 602, the first user that performs the touching, obtain user biometric features of the first user, and perform identity recognition based on the user biometric features.

In an optional implementation, the touch-enabled device 601 is configured to obtain the touching of the user and report the touching to the identity recognition model 603; and the identity recognition model 603 is specifically configured to: after the user performs the touching on the touch-enabled device 601, report, by the touch-enabled device 601, the touching to the identity recognition model 603.

In an optional implementation, the identity recognition model 603 is specifically configured to determine a timestamp of the touching based on the touching reported by the touch-enabled device 601; and search the video streams uploaded by the monitoring device 602 for a video stream corresponding to the timestamp, and recognize a user in the video stream corresponding to the timestamp as the first user.

In an optional implementation, the monitoring device 602 is further configured to: monitor a behavior that the user performs the touching on the touch-enabled device 601, and upload, to the identity recognition model 603, a video stream that includes a performing behavior of the touching.

In an optional implementation, the identity recognition model 603 is further configured to: determine, based on image analysis on the video stream including the performing behavior of the touching, that the user who performs the touching is the first user.

In an optional implementation, the identity recognition model 603 is specifically configured to: perform image analysis on the video stream corresponding to the first user, to obtain an image of the first user; and perform biometric feature extraction based on the image of the first user, to obtain the biometric features of the first user.

In an optional implementation, the identity recognition model 603 is specifically configured to: compare the obtained biometric features of the first user with prestored user identity features; and if the biometric features of the first user are included in the prestored user identity features, determine that the first user is a prestored user.

In an optional implementation, the identity recognition model 603 is further configured to: confirm an identity recognition result, and communicate information about the identity recognition result.

In an optional implementation, scenarios on the user side include: a facial recognition-based payment and/or iris scanning-based payment scenario, a facial recognition-based access and/or iris scanning-based access scenario, a facial recognition-based public transportation boarding scenario and/or iris scanning-based public transportation boarding scenario.

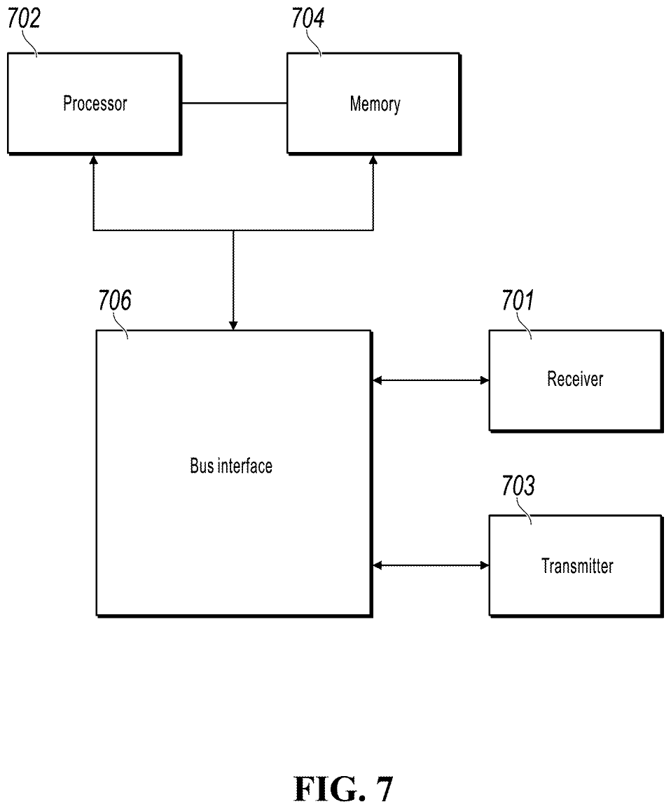

According to a fourth aspect, based on the same inventive concept as that of the identity recognition method in the previous implementation, the present disclosure further provides a server. As shown in FIG. 7, the server includes a memory 704, a processor 702, and a computer program that is stored in the memory 704 and that can run on the processor 702, and the processor 702 implements steps of any one of the previous identity recognition methods when executing the program.

In FIG. 7, in a bus architecture (represented by a bus 700), the bus 700 can include any quantity of interconnected buses and bridges. The bus 700 links together various circuits of one or more processors represented by the processor 702 and one or more memories represented by the memory 704. The bus 700 can further link together various other circuits of a peripheral device, a voltage regulator, a power management circuit, etc., which are well-known in the art. Therefore, details are omitted here for simplicity in the present specification. A bus interface 706 provides an interface between the bus 700, a receiver 701, and a transmitter 703. The receiver 701 and the transmitter 703 can be the same component that is, a transceiver, and provide units configured to communicate with various other apparatuses on a transmission medium. The processor 702 is responsible for managing the bus 700 and common processing, and the memory 704 can be configured to store data used when the processor 702 performs an operation.

According to a fifth aspect, based on the same inventive concept as that of the identity recognition method in the previous implementation, the present disclosure further provides a computer readable storage medium on which a computer program is stored, and the program is executed by a processor to implement steps of any one of the previous identity recognition methods.

The present specification is described with reference to the flowcharts and/or block diagrams of the method, the device (system), and the computer program product based on the implementations of the present specification. It is worthwhile to note that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate a device for implementing a specific function in one or more processes in the flowcharts and/or in one or more blocks in the block diagrams.

These computer program instructions can be stored in a computer readable memory that can instruct the computer or the another programmable data processing device to work in a specific way, so the instructions stored in the computer readable memory generate an artifact that includes an instruction device. The instruction device implements a specific function in one or more processes in the flowcharts and/or in one or more blocks in the block diagrams.

These computer program instructions can be loaded onto the computer or another programmable data processing device, so a series of operations and operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred implementations of the present specification have been described, a person skilled in the art can make changes and modifications to these implementations once they learn the basic inventive concept. Therefore, the following claims are intended to be construed as to cover the preferred implementations and all changes and modifications falling within the scope of the present specification.

Clearly, a person skilled in the art can make various modifications and variations towards the present specification without departing from the spirit and scope of the present specification. The present specification is intended to cover these modifications and variations of the present specification provided that they fall within the scope of protection defined by the following claims and their equivalent technologies.

What is claimed is:

1. A computer-implemented method for recognizing an identity of a first user from multiple users in an environment, wherein the method comprises:
obtaining, from one or more monitoring devices, one or more video streams including images of the multiple users in the environment;
obtaining, from a touch-enabled device, information indicative of a touch;
identifying, based on the one or more video streams and the information indicative of the touch, a particular user from the multiple users as the first user;
obtaining biometric features of the first user; and
performing identity recognition of the first user based on the biometric features of the first user.

2. The computer-implemented method of claim 1, wherein identifying a particular user from the multiple users as the first user comprises:
determining, based on the information indicative of the touch, a timestamp associated with the touch;
searching, using an identity recognition model, the one or more video streams for a portion of the one or more video streams corresponding to the timestamp; and
identifying a user captured in the portion as the first user.

3. The computer-implemented method of claim 1, wherein obtaining the information indicative of the touch from the touch-enabled device comprises:
receiving, at the identity recognition model, a video stream transmitted by the one or more monitoring devices responsive to detecting a gesture of a user touching the touch-enabled device.

4. The computer-implemented method of claim 1, wherein identifying a particular user from the multiple users as the first user further comprises:
performing, using the identity recognition model, image analysis on the video stream that captures the gesture of the touching.

5. The computer-implemented method of claim 1, wherein obtaining biometric features of the first user comprises:
performing image analysis on the video stream corresponding to the first user to obtain an image of the first user; and
performing biometric feature extraction on the image of the first user to obtain the biometric features of the first user.

6. The computer-implemented method of claim 1, wherein performing identity recognition of the first user based on the biometric features of the first user comprises:
comparing the obtained biometric features of the first user with prestored user identity features;
determining that the biometric features of the first user are included in the prestored user identity features; and
in response, determining that the first user is a prestored user.

7. The computer-implemented method of claim 6, further comprising:
generating an identity recognition result; and
displaying or broadcasting information about the identity recognition result.

8. The computer-implemented method of claim 1, wherein the environment comprises one or more of: a facial recognition-based payment processing environment, an iris scanning-based payment processing environment, a facial recognition-based access granting environment, an iris scanning-based access granting environment, a facial recognition-based public transportation boarding environment, or an iris scanning-based public transportation boarding environment.

9. A non-transitory, computer-readable medium storing one or more instructions executable by a computer system to perform operations for recognizing an identity of a first user from multiple users in an environment, wherein the operations comprise:
obtaining, from one or more monitoring devices, one or more video streams including images of the multiple users in the environment;
obtaining, from a touch-enabled device, information indicative of a touch;
identifying, based on the one or more video streams and the information indicative of the touch, a particular user from the multiple users as the first user;
obtaining biometric features of the first user; and
performing identity recognition of the first user based on the biometric features of the first user.

10. The non-transitory, computer-readable medium of claim 9, wherein identifying a particular user from the multiple users as the first user comprises:
determining, based on the information indicative of the touch, a timestamp associated with the touch;
searching, using an identity recognition model, the one or more video streams for a portion of the one or more video streams corresponding to the timestamp; and
identifying a user captured in the portion as the first user.

11. The non-transitory, computer-readable medium of claim 9, wherein obtaining the information indicative of the touch from the touch-enabled device comprises:
receiving, at the identity recognition model, a video stream transmitted by the one or more monitoring devices responsive to detecting a gesture of a user touching the touch-enabled device.

12. The non-transitory, computer-readable medium of claim 9, wherein identifying a particular user from the multiple users as the first user further comprises:
performing, using the identity recognition model, image analysis on the video stream that captures the gesture of the touching.

13. The non-transitory, computer-readable medium of claim 9, wherein obtaining biometric features of the first user comprises:
performing image analysis on the video stream corresponding to the first user to obtain an image of the first user; and
performing biometric feature extraction on the image of the first user to obtain the biometric features of the first user.

14. The non-transitory, computer-readable medium of claim 9, wherein performing identity recognition of the first user based on the biometric features of the first user comprises:
comparing the obtained biometric features of the first user with prestored user identity features;
determining that the biometric features of the first user are included in the prestored user identity features; and
in response, determining that the first user is a prestored user.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for recognizing an identity of a first user from multiple users in an environment, wherein the operations comprise:
obtaining, from one or more monitoring devices, one or more video streams including images of the multiple users in the environment;
obtaining, from a touch-enabled device, information indicative of a touch;
identifying, based on the one or more video streams and the information indicative of the touch, a particular user from the multiple users as the first user;
obtaining biometric features of the first user; and
performing identity recognition of the first user based on the biometric features of the first user.

16. The computer-implemented system of claim 15, wherein identifying a particular user from the multiple users as the first user comprises:
determining, based on the information indicative of the touch, a timestamp associated with the touch;
searching, using an identity recognition model, the one or more video streams for a portion of the one or more video streams corresponding to the timestamp; and
identifying a user captured in the portion as the first user.

17. The computer-implemented system of claim 15, wherein obtaining the information indicative of the touch from the touch-enabled device comprises:
receiving, at the identity recognition model, a video stream transmitted by the one or more monitoring devices responsive to detecting a gesture of a user touching the touch-enabled device.

18. The computer-implemented system of claim 15, wherein identifying a particular user from the multiple users as the first user further comprises:
performing, using the identity recognition model, image analysis on the video stream that captures the gesture of the touching.

19. The computer-implemented system of claim 15, wherein obtaining biometric features of the first user comprises:
performing image analysis on the video stream corresponding to the first user to obtain an image of the first user; and
performing biometric feature extraction on the image of the first user to obtain the biometric features of the first user.

20. The computer-implemented system of claim 15, wherein performing identity recognition of the first user based on the biometric features of the first user comprises:
comparing the obtained biometric features of the first user with prestored user identity features;
determining that the biometric features of the first user are included in the prestored user identity features; and
in response, determining that the first user is a prestored user.
